(19) United States
(12) Patent Application Publication
(10) Pub. No.: US 2021/0347430 A1
(43) Pub. Date: Nov. 11, 2021

(54) BICYCLE BASKET ASSEMBLY

(71) Applicant: Delta Cycle Corporation, Randolph, MA (US)

(72) Inventors: Errol Drew, Los Gatos, CA (US); Joseph Molinari, San Rafael, CA (US)

(73) Assignee: Delta Cycle Corporation

(21) Appl. No.: 17/180,962

(22) Filed: Feb. 22, 2021

Related U.S. Application Data
(60) Provisional application No. 63/022,742, filed on May 11, 2020.

(51) Int. Cl. B62J 9/21

(52) U.S. Cl. CPC B62J 9/21

(57) ABSTRACT

Featured is a bicycle basket assembly comprising a basket, a frame for the basket, a handlebar anchor coupled to the frame and a support brace coupled to the handlebar anchor and securable under a handlebar stem of the bicycle.

### RELATED APPLICATIONS

This application claims benefit of and priority to U.S. Provisional Application Ser. No. 63/022,742 filed May 11, 2020, under 35 U.S.C. §§ 119, 120, 363, 365, and 37 C.F.R. § 1.55 and § 1.78, which is incorporated herein by this reference.

### FIELD OF THE INVENTION

This subject disclosure relates to baskets for bicycles and other vehicles.

### BACKGROUND OF THE INVENTION

A typical bicycle front basket is formed of wire, coupled to the handlebars, and is supported by brackets extending downward at a rearward angle from the bottom of the basket and coupled to the bicycle forks or front tire skewer.

As such, the typical bicycle basket is costlier to ship and generally cannot be displayed in a retail environment on peg hook displays.

### BRIEF SUMMARY OF THE INVENTION

Featured, in one preferred embodiment, is an easier to assemble, lower cost, and removable bicycle basket which can be collapsed for less costly shipping and easier display in a retail environment on hook displays.

Featured is a bicycle basket assembly comprising a basket, a frame for the basket, a handlebar anchor coupled to the frame and a support brace coupled to the handlebar anchor and securable under a handlebar stem of the bicycle.

In one example, the basket is collapsible and/or removable from the frame. The basket may include flaps securable over the frame, The basket preferably hangs from the frame, The basket can be made of fabric and may include one or more handles. Preferably, the frame forms a polygon. The handlebar anchor preferably includes a pair of spaced handlebar clamps. And, the handlebar anchor support brace may include one or more straps attached to the handlebar anchor.

Also featured is a bicycle basket assembly comprising a frame, a collapsible fabric basket hanging from the frame, and a handlebar anchor coupled to the frame including a pair of spaced handlebar clamps. The bicycle basket assembly may further include a support brace coupled to the handlebar anchor and securable under a handlebar stem of the bicycle and the support brace may include one or more straps attached to the handlebar anchor coupled to the support brace.

Also featured is a bicycle basket assembly comprising a basket, a frame for the basket, at least one handlebar clamp associated with the frame, and a support brace securable under a handlebar stem of the bicycle. The handlebar clamp preferably resides underneath a planar handlebar anchor secured to the frame. The support brace preferably includes one or more straps attached to the planar handlebar anchor.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional view showing an example of a new bicycle basket assembly attached to the front of a bicycle;

FIG. 2 is schematic three-dimensional view showing the handlebar anchor component of the basket assembly;

FIG. 3 is a rear schematic view of the bicycle basket assembly;

FIG. 4 is another schematic view of the bicycle basket assembly;

FIG. 5 is a schematic front view of the bicycle basket assembly; and

FIG. 6 is a view of how the support brace strap can be secured after passing under the handlebar stem.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

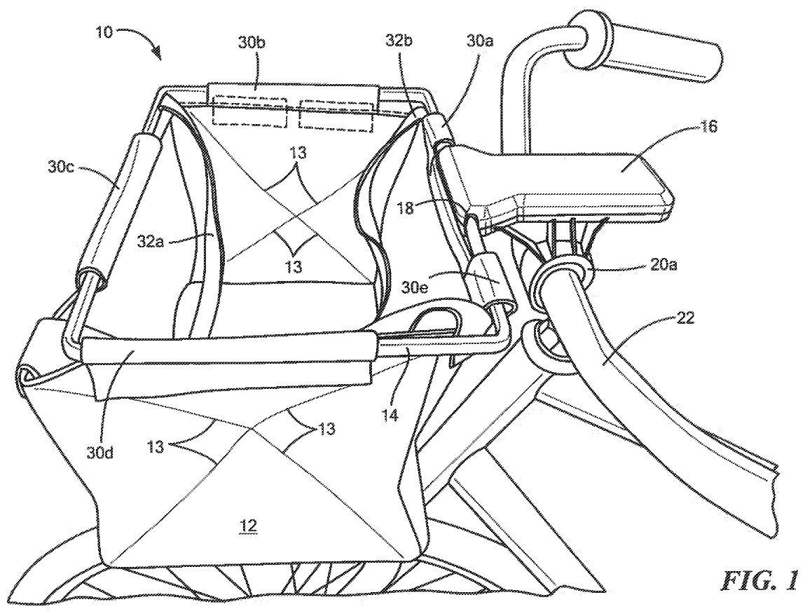

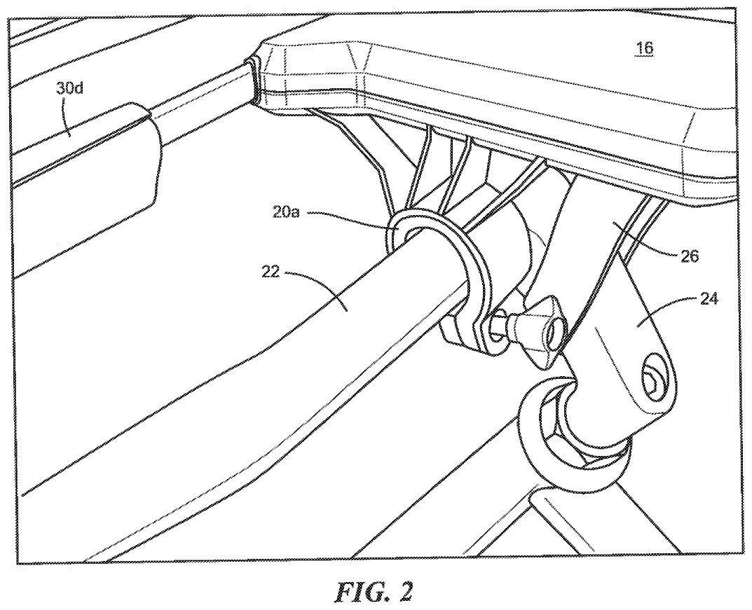

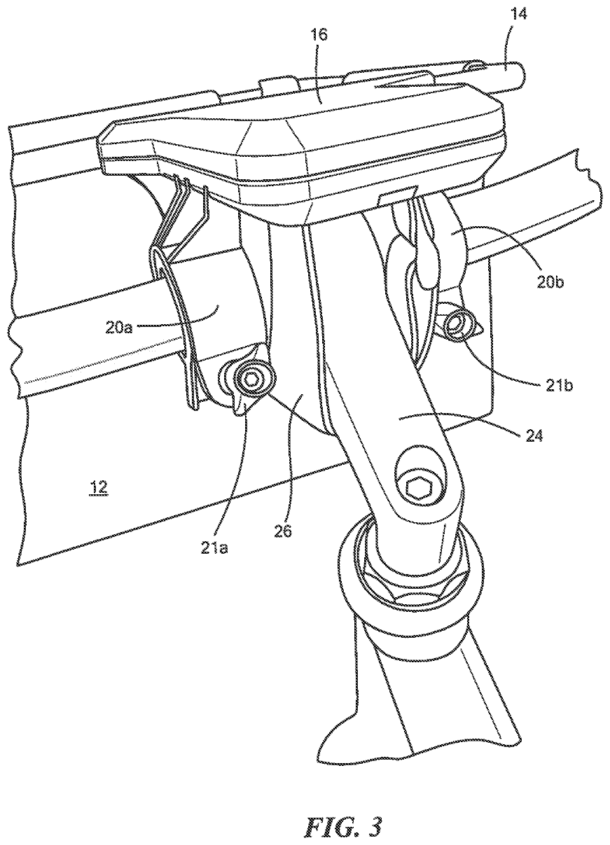

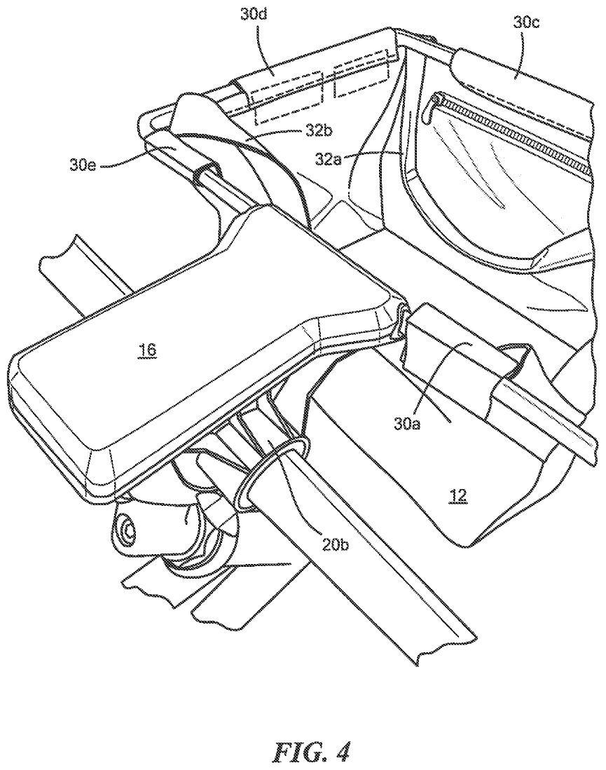

In one embodiment, bicycle basket assembly 10, FIGS. 1-2 includes basket 12 preferably made of fabric so as to be easily collapsible for shipping and retail display. Side seam lines 13, for example, assist in collapsing the basket flat. Basket 12 preferably hangs from tubular rigid (e.g., metal) polygon shaped (e.g., rectangular) frame 14. Handlebar anchor 16, usually made of plastic, is fixedly coupled to frame 14 as shown at 18 and preferably includes a pair of spaced handlebar clamps 20a, 20b (see FIGS. 3-4) securable about the bicycle handlebar 22 on the opposite sides of handlebar stem 24 using, for example, fasteners 21a and 21b, respectively. In this example, each handlebar clamp is a yoke shaped clamp device securable over a handlebar. Molded anchor 16 in this embodiment includes a planar top section and clamps 20a and 20b on the underside thereof. Handlebar anchor assembly 16 also preferably includes a support brace, preferably one or more straps 4 securable under handlebar stem 26 to prevent the basket, when heavily loaded, from rotating downward. Strap 26 may include Velcro for securing one or more ends thereof to the handlebar anchor after passing underneath the stem or two straps may be used, each secured to the handlebar anchor at one end and then secured together after one or both straps pass underneath handlebar stem 24. For example, as shown in FIG. 6, strap 26 is attached to anchor 16 at 27 and extends down under stem 24 and then through loop 29 fixed to anchor 16. Male Velcro on strap end 31 releasably mates with female Velcro on strap portion 33. In another version, there are two straps each with a buckle.

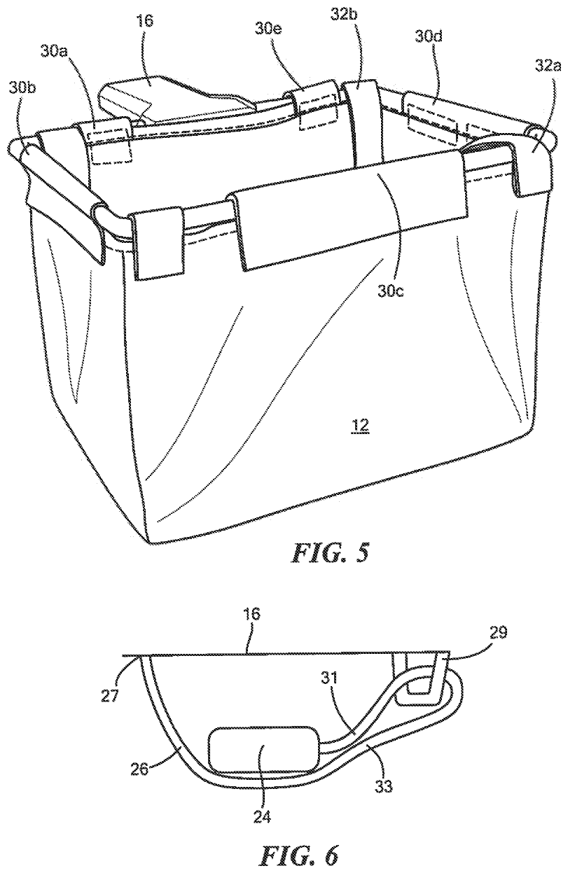

Basket 12 is preferably securable to and removeable from frame 14 via top end opening rim flaps 30a-30e or sleeves, preferably one or more associated with each side of the basket. See FIG. 5. Flaps 30a and 30e, for example, secure the rear top of the basket to the rear of the frame on opposite sides of the handlebar stem. Velcro may be used to secure each flap about a respective frame member. In this way, basket 12 is not only collapsible, it can be removed from frame 14 and used, for example, for shopping. Basket handles (e.g., straps) 32a and 32b can be used to carry the basket. Strap 32a, for example, may extend from the front left top corner of the basket to the top front right corner of the basket and strap 32b may extend from the left rear top corner of the basket to the right rear top corner of the basket.

The result, in the preferred embodiment, is an easier to assemble, lower cost, and removable bicycle basket which can be collapsed for lest costly shipping and easier display in a retail environment.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A bicycle basket assembly comprising:
a basket;
a frame for the basket;
a handlebar anchor coupled to the frame; and
a support brace coupled to the handlebar anchor and securable under a handlebar stem of the bicycle.

2. The bicycle basket assembly of claim 1 in which the basket is removable from the frame.

3. The bicycle basket assembly of claim 2 in which the basket includes flaps securable over the frame.

4. The bicycle basket assembly of claim 1 in which the basket is collapsible.

5. The bicycle basket assembly of claim 1 in which the basket hangs from the frame.

6. The bicycle basket assembly of claim 1 in which the basket is made of fabric.

7. The bicycle basket assembly of claim 1 in which the basket includes one or more handles.

8. The bicycle basket assembly of claim 1 in which the frame forms a polygon.

9. The bicycle basket assembly of claim 1 in which the handlebar anchor includes a pair of spaced handlebar clamps.

10. The bicycle basket assembly of claim 1 in which the handlebar anchor support brace includes one or more straps attached to the handlebar anchor.

11. A bicycle basket assembly comprising:
a frame;
a collapsible fabric basket hanging from the frame; and
a handlebar anchor coupled to the frame including a pair of spaced handlebar clamps.

12. The bicycle basket assembly of claim 11 further including a support brace coupled to the handlebar anchor and securable under a handlebar stem of the bicycle.

13. The bicycle basket assembly of claim 12 in which the support brace includes one or more straps attached to the handlebar anchor coupled to the support brace.

14. The bicycle basket assembly of claim 11 in which the basket includes operable flaps securable over the frame.

15. The bicycle basket assembly of claim 11 in which the basket includes one or more handles.

16. The bicycle basket assembly of claim 11 in which the frame forms a polygon.

17. A bicycle basket assembly comprising:
a basket;
a frame for the basket;
at least one handlebar clamp associated with the frame; and
a support brace securable under a handlebar stem of the bicycle.

18. The bicycle basket assembly of claim 17 in which the handlebar clamp resides underneath a planar handlebar anchor secured to the frame.

19. The bicycle basket assembly of claim 18 in which the handlebar anchor support brace includes one or more straps attached to the planar handlebar anchor.

20. The bicycle basket assembly of claim 17 in which the basket is removable from the frame.

21. The bicycle basket assembly of claim 19 in which the basket includes flaps securable over the frame.

22. The bicycle basket assembly of claim 17 in which the basket is collapsible.

23. The bicycle basket assembly of claim 17 in which the basket hangs from the frame.

24. The bicycle basket assembly of claim 17 in which the basket is made of fabric.

25. The bicycle basket assembly of claim 17 in which the basket includes one or more handles.

26. The bicycle basket assembly of claim 17 in which the frame forms a polygon.
